(19) United States
(12) Patent Application Publication
(10) Pub. No.: US 2011/0094097 A1
(43) Pub. Date: Apr. 28, 2011

(54) Tape winding device for wire material, and system of manufacturing tape-wound insulation core

(76) Inventors: Hisao Saito, Ibaraki (JP); Toshiyuki Wakabayashi, Ibaraki (JP)

(21) Appl. No.: 10/564,550

(22) PCT Filed: Jul. 15, 2004
(86) PCT No.: PCT/JP2004/010430

§ 371 Date: Mar. 8, 2006

(30) Foreign Application Priority Data
Jul. 17, 2003 (JP) 2003-198612

(51) Int. Cl. B23P 19/00

(52) U.S. Cl. 29/745

(57) ABSTRACT

A tape winding device (100) for a wire material, comprising a plurality of tension control rolls (110) and (120) installed on the flat surface of a tape winding flyer base plate (107) parallel with a hollow shaft (101). A tape body (1) is supplied from a tape pad (102) to the tape winding flyer base plate (107) according to the rotation of a first drive source (106), and the tape body (1) supplied to the tape winding flyer base plate (107) according to the rotation of a first drive source (106), and the tape body (1) supplied to the tape winding flyer base plate (107) is adjusted by the plurality of tension control rolls (110) and (120) so that its tension is made constant and wound on the wire material (10) at the tip of the hollow shaft (101) by the rotation of a second drive source (109). Thus, the tape body can be wound on the wire material without extending or cutting the tape body.

### TECHNICAL FIELD

The present invention relates to a tape winding device for wire material and a system of manufacturing a tape-wound insulation core, and particularly to a tape winding device and a system of manufacturing a tape-wound insulation core for forming an insulation layer of a high-precision foamed coaxial cable composed of an inner conductor formed by winding the outer circumferential insulator thereof and an outer conductor of a braided member of a conductive thin wire.

### BACKGROUND TECHNOLOGY

With growth of a high information society, requests for speedup in transmission rates and transmission precisions in information-communication equipment and test/inspection apparatuses for semiconductor devices applied to the information-communication equipment are increased. Accordingly, improvements in speedup in transmission rates and transmission precisions are also requested in coaxial cables and coaxial cords.

It is to be noted that typical electrical properties demanded for a coaxial cable are as follows.

Propagation delay time (Td)=√∈/0.3(nS/m)

Relative transmission rate (V)=100/√∈(%)

Characteristic impedance (Z₀)=60/√∈·LnD/d(Ω)

Electrostatic capacity (C)=55.63∈/LnD/d(PF/m)

where ∈: dielectric constant of insulator, D: outer diameter of insulator (inner diameter of outer conductor), and d: outer diameter of conductor (outer diameter of inner conductor).

From the above-described respective formulae, it is understood that the dielectric constant of the insulator, and outer diameters of the inner conductor and the insulator are concerned with transmission characteristics of the coaxial cable, that the lower value of the dielectric constant brings about the higher transmission characteristics, and that a ratio and a fluctuation are remarkably concerned with outer diameters of the inner conductor and the insulator.

Particularly, it is understood that an ideal situation as to a characteristic impedance and an electrostatic capacity is in a small dielectric constant of an insulator and a slight fluctuation thereof, and in slight fluctuations of the outer diameter of the inner conductor and the outer diameter of the insulator (the inner diameter of a shield layer), besides in that shapes of them are formed in a more complete round.

In a conventional coaxial cable, a foamed insulator to be applied to the coaxial cable aims at acceleration of a transmission rate by reducing as much as possible a propagation delay time of a cable so that a porosity (a ratio of foaming) is made to be 60% or more at present, whereby voids are increased to obtain 1.4 or less dielectric constant (∈) of the insulator. As a result, reduction of transmission time, decrease in attenuation and the like are intended. An example of an insulator material a porosity of which is made to be 60% or more and a dielectric constant of which is made to be 1.4 or less, there is a member which is prepared by winding a polytetrafluoroethylene (PTFE) porous tape body (see patent literary documents 1 and 2) around the outer circumference of an inner conductor, and subjecting the wound inner conductor to calcination treatment during or after winding the porous tape. As another example of the porous tape body, there is a polyethylene tape body having an average molecular weight of five million or more (see patent literary document 3). These insulator layers involve qualitatively remarkable fluctuations in their thicknesses and porosities so that improvements in stability of transmission characteristics of a coaxial cable are strongly demanded.

Particularly, in a coaxial cable having a thin diameter conductor wherein an inner conductor size is made to be 24 or more AWG size, and a characteristic impedance value is made to be 50Ω, fluctuations in thickness, outer diameter, porosity, calcination and the like are remarkable drawbacks in order to achieve elimination of fluctuations in transmission characteristics to stabilize them.

Furthermore since an insulator layer is constituted by winding a porous tape body around the outer circumference of an inner conductor in an overlapped manner, irregularities appear on an outer diameter of the conductor at overlapped portions of the tape body around the outer circumference thereof due to gaps and overlapping, whereby fluctuations in dielectric constant and the outer diameter increase remarkably.

Moreover, since the insulating layer uses a porous tape body having a very low mechanical strength, it is required to make a tension of the tape body to be very small in order to eliminate elongation and break of the tape body itself at the time of winding it as well as to eliminate elongation and disconnection of a superfine inner conductor caused by winding of the porous tape body. As a result, irregularities in an outer diameter and fluctuations in the outer diameter become more remarkable, besides a degree of adhesion of the porous material to the inner conductor is very low and weak, so that fluctuations in dielectric constant and the outer diameter increase further.

Furthermore, there is a significant problem in that an outline of such insulator is hardly formed into a cylinder having a complete circular section in addition to such a problem that fluctuations are removed while maintaining an outer diameter of the insulator to a predetermined outer diameter.

Although a variety of problems to be solved in the case where an insulator of a coaxial cable is constituted with use of a porous tape body have been enumerated above, a tape winding device wherein a thin tape can be wound stably around an outer circumference of a wire material such as a superfine wire at a high speed while suppressing variations in a tension is disclosed (see patent literary document 4) as a conventional example of a tape body winding device wherein a thin tape is wound around an outer circumference of an inner conductor to form an insulator.

The invention disclosed in the patent literary document 4 will be described specifically by referring to FIG. 5 wherein a tape winding device for a wire material is provided with a reel shaft 51 installed vertically in which a throughhole 52 for passing upwardly a wire material 521 through the inside of the reel shaft 51 along the centerline thereof from the bottom of the reel shaft is defined, and air outlets 53, 53, constituting an air bearing, are defined respectively on an outer circumference of a shaft 51A and on a flange surface supporting a tape reel flange from the downward direction so that the reel shaft 51 is in a rotatable fashion; a flayer 510 of an inverted funnel shape installed rotatably at the upper part of the reel shaft in a coaxial fashion; a tape cover 517 bonded adhesively on the outer surface of the flyer; a tape winding guide 518 and a tape holding member 519 disposed on the upper part of the flyer to be rotated therewith associatingly; and a motor 57 for rotating the reel shaft and a motor 513 for rotating the flyer in an individual fashion. In the constitution of the tape winding device for a wire material described above, a tape 532 reeled out from a tape reel 531 fitted to the reel shaft 51 is inserted in a guide hole 516 disposed on an outer periphery of the lower part of the flayer, thereafter the tape is allowed to slip through the under side of the tape cover to be introduced on a wire material 521 via the tape winding guide and the tape holding member, further a predetermined rotational resistance derived from air blown out from the air outlets is given to the tape reel to move up it, while maintaining the situation achieved, the wire material is passed through at a predetermined rate and the flayer is simultaneously rotated at a constant speed, and the tape is wound around the outer circumference of the wire material while rotating the reel shaft at a rate in response to a reel winding diameter.

The literary document describes advantages to the effect that the tape winding device for a wire material is hardly affected adversely by centrifugal force or wind, that even in a constant winding operation, variations in a tension of a tape are suppressed by means of an automatic minute adjustment function provided between the tape reel floated by air and the reel shaft, that a range of fluctuations in a tape tension becomes more reduced in a winding part, so that high-speed winding can be carried out under a stable condition while maintaining an adequate tension in case of applying even an easily breakable ultrathin tape, and that a winding pitch and a wound condition of a tape are constant.
Patent literary document 1: Patent Publication No. 42-13560
Patent literary document 2: Patent Publication No. 51-18991
Patent literary document 3: Patent Laid-Open Application No. 2001-297633
Patent literary document 4: Patent Laid-Open Application No. 6-124614

However, the above-described conventional tape winding device for a wire material involves the following problems.

(1) Since the tape reel is floated with air and the tape reel is rotated by rotation of the reel shaft to feed the tape, a tension for feeding the tape varies easily dependent upon magnitude in an amount of tape body wound around the tape reel.

(2) Due to imbalance in the number of revolutions between the motors 57 and 513, a tape tension varies to change an amount of the tape wound so that it is difficult to maintain a constant outline of a wound tape shape.

(3) A tape row length up to the tape holding member 519 in tape winding comes to be elongated, whereby a tape tension in the tape feed section does not coincide with that of the tape winding section, so that breakage of the tape occurs easily by means of a wind pressure at the time of winding the tape.

(4) Although a winding tension in the tape is produced by contact of the tape with the guide hole 516, the tape cover 517, and the tape winding guide 518, it varies easily due to the fact that their contact areas are comparatively wide, and dependent upon the number of revolutions of the flyer 510.

(5) Because of the reasons described in the above paragraphs (1) and (2), feed of the tape and a tape tension due to tape winding become unstable, whereby an outline of tape wound becomes irregular, and the tape is broken easily.

(6) Since a tape reeled out from the tape reel extending from the tape reel to the tape wound (the tape holding member 519) is long, a tape tension changes easily as a result of receiving wind pressure derived from rotation of the flyer 510.

Accordingly, an object of the present invention is to provide a tape winding device for a wire material and a system of manufacturing a tape-wound insulation core by which the above-described problems can be solved and in which winding of a tape body can be made without elongation and breakage of the tape body, an outer diameter of an insulator can be maintained at a predetermined outer diameter, an outline of an insulator layer wound may be made to be constant, and the outline can be formed easily into a complete circular shape in a formation of the insulator layer made of a porous tape body of a coaxial cable.

### DISCLOSURE OF THE INVENTION

In order to achieve the above-described object, the present invention provides a tape winding device for a wire material, characterized by comprising a tape feed section composed of a hollow shaft having a throughhole for passing a wire material therethrough, a tape pad secure part secured to the hollow shaft for fixing a tape pad on which a tape body is wound, and a first drive source for driving rotatively the tape pad secure part; and

a tape winding section composed of a tape winding flyer installed coaxially on the outside of the tape feed section in a rotatable manner, a plurality of tension control rolls installed on a flat surface of the tape winding flyer parallel with the hollow shaft, and a second drive source connected to the tape winding flyer; and that:

the tape body is supplied from the tape pad to the tape winding flyer with a rotation by means of the first drive source, a tension of the tape body supplied to the tape winding flyer is made constant by means of the plurality of the tension control rolls, and the tape body is wound on the wire material at the tip of the hollow shaft by the rotation of the second drive source.

According to the present invention, it becomes possible to make a tension of a porous tape body (particularly a porosity of 60% or more) for winding on a wire material and a winding angle thereof to be constant, whereby irregularities in an outer diameter of an insulator due to fluctuations in a winding tension, and fluctuations in the outer diameter may be reduced.

Moreover, since influences by wind force due to rotation are reduced in addition to make a winding tension of the porous tape body constant, it becomes possible that cutoff of the porous tape body due to winding is eliminated, whereby the tape body is uniformly wound, so that fluctuations in an outer diameter of an insulator, surface waviness and the like are eliminated.

In a preferred manner of the invention, the tape pad secure part and the tape winding flyer are rotated in the same direction by the first and second drive sources, whereby the tape body is wound on the wire material. Furthermore, the tape winding flyer is composed of a disc-shaped base plate, the plurality of tension control rolls implanted vertically on the base plate are fitted to a guide board on the other ends thereof, and tape guide rolls function for introducing the tape body to the tip of the hollow shaft are provided on one or two or more of the plurality of tension control rolls and the guide board. Besides, a shorting bar is secured to the top surface of the guide board, and the tape guide rolls are disposed on the shorting bar.

Moreover, in order to achieve the above-described object, the present invention provides a system of manufacturing a tape-wound insulation core, characterized by comprising a tape feed section composed of a hollow shaft having a throughhole for passing a wire material therethrough, a tape pad secure part secured to the hollow shaft for fixing a tape pad on which a tape body is wound, and a first drive source for driving rotatively the tape pad secure part; and

a tape winding section composed of a tape winding flyer installed coaxially on the outside of the tape feed section in a rotatable manner, a plurality of tension control rolls installed on a flat surface of the tape winding flyer parallel with the hollow shaft, and a second drive source connected to the tape winding flyer;

the tape body being supplied from the tape pad to the tape winding flyer with a rotation by means of the first drive source, a tension of the tape body supplied to the tape winding flyer being made constant by means of the plurality of the tension control rolls;

one or plural tape winding devices for a wire material in which the tape body is wound on the wire material at the tip of the hollow shaft by the rotation of the second drive source;

a feed unit for feeding the wire material;

a take-over device for taking over the tape-wound insulation core prepared by winding the tape body on the wire material by means of the tape winding device;

an outline shaping device for shaping the tape-wound insulation core into a predetermined shape having a predetermined outer diameter; and

a take-up device for taking up the shaped tape-wound insulation core.

According to the present invention, it is also possible that the tape-wound insulation core is easily shaped into the one having a predetermined outer diameter and a cylindrical shape of a complete circle.

In a preferred manner of the invention, the outline shaping device is disposed in between the take-over device and the take-up device, and composed of shaping dies including a complete circular hole having a predetermined inner diameter and a predetermined inner diameter length.

The present invention has been constituted as described above, so that it has the following advantages of the invention.

In accordance with the present invention, a tape can be reeled out from a tape pad without changing a tape tension, and a tension in case of winding the tape on a wire material (conductor) may be adjusted by the tension control rolls in the tape winding flyer to make the tension constant. Accordingly, it becomes easy to wind the tape on the wire material, whereby a degree of close contact in the tape body due to winding is made constant, so that a tape winding device which can effect stable tape winding is provided. As a result, it becomes stable to manufacture an electric wire by means of tape winding.

Besides, a reeled-out tension and a winding tension of a tape body can make always constant and to be the minimum tension, and when the tape body is allowed to be in contact with tension control rolls and tape guide rolls with a short time interval, influences of a wind pressure due to winding can be reduced. Hence, it becomes possible to provide a tape winding device which can wind even a tape body with a low tension.

Further, based on cooperation with predetermined shaping dies, an outline of a tape-wound insulation core can be easily shaped, and thus, a system of manufacturing a tape-wound insulation core which can extremely easily shape an outline of a tape-wound insulation core is provided.

### BRIEF DESCRIPTION OF THE DRAWINGS

FIG. 1 is an overall view showing a system of manufacturing a tape-wound insulation core including a tape winding device according to the present invention.

FIG. 2 is a sectional view showing a specific example of the tape winding device according to the present invention.

FIG. 3 is a perspective view showing a specific example of a main body part of the tape winding device of the present invention.

FIGS. 4(a) to 4(d) are views each showing a specific example of the main body part of the winding device wherein a tape tension is made to be a predetermined value.

FIG. 5 is a sectional view showing a conventional tape winding device.

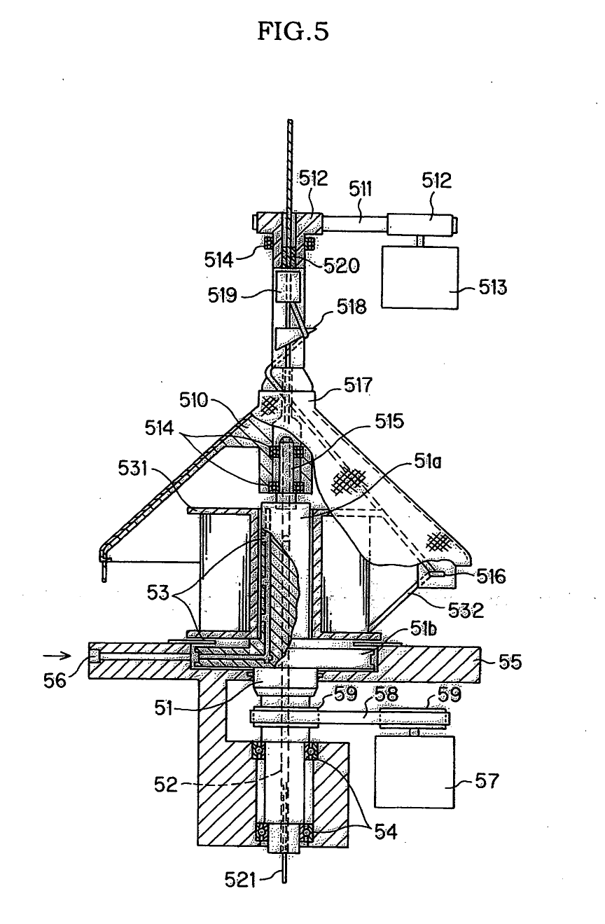

### BEST MODE FOR EMBODYING THE INVENTION

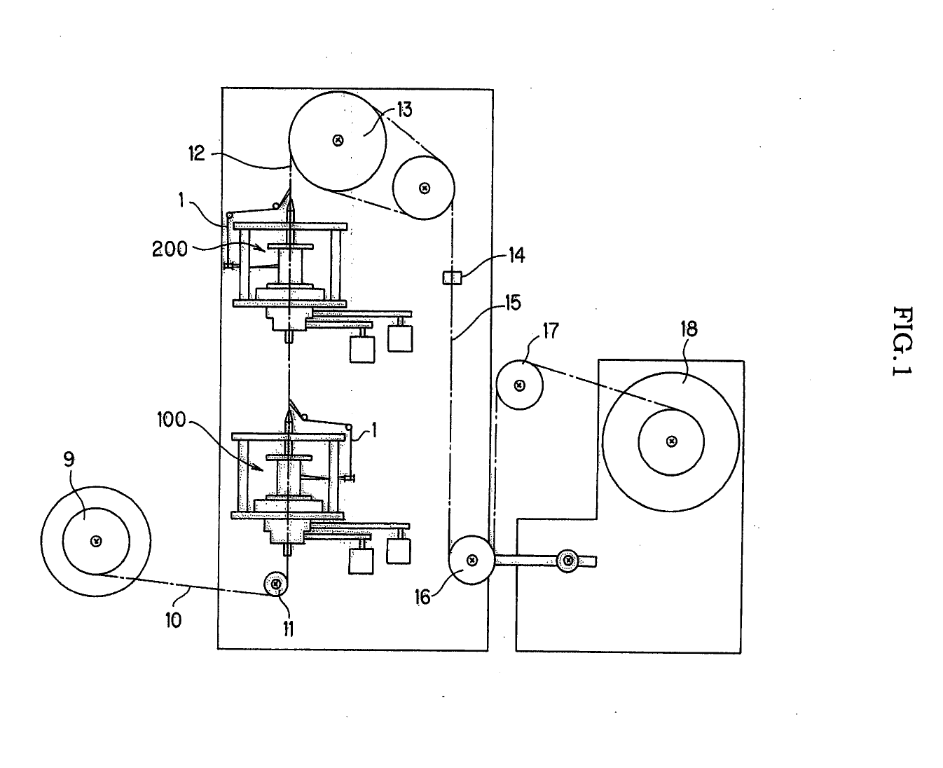

In the following, a manner of practice of the present invention will be described based on FIGS. 1 to 4.

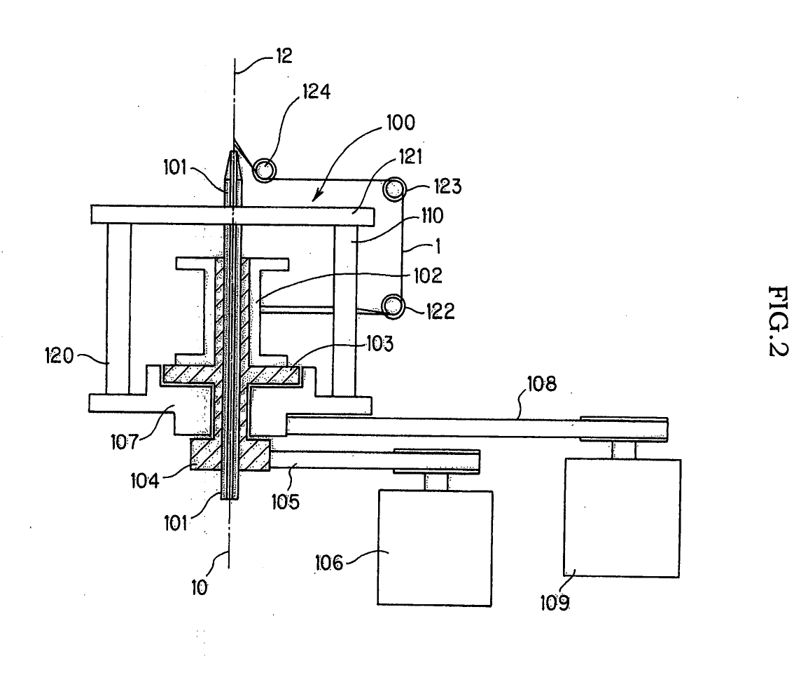

FIG. 1 is an overall view showing a system of manufacturing a tape-wound insulation core including a tape winding device according to the present invention, and FIG. 2 is a sectional view showing a specific example of the tape winding device according to the present invention.

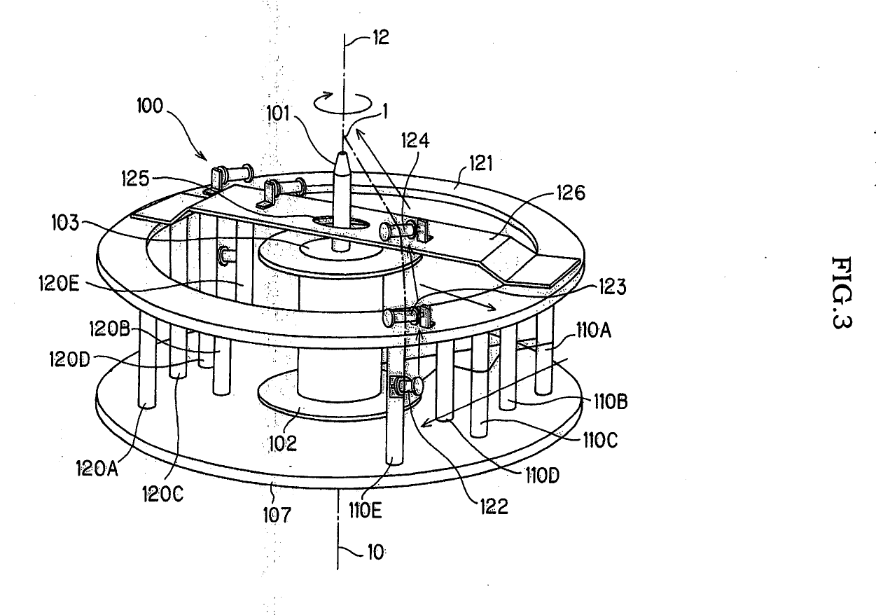

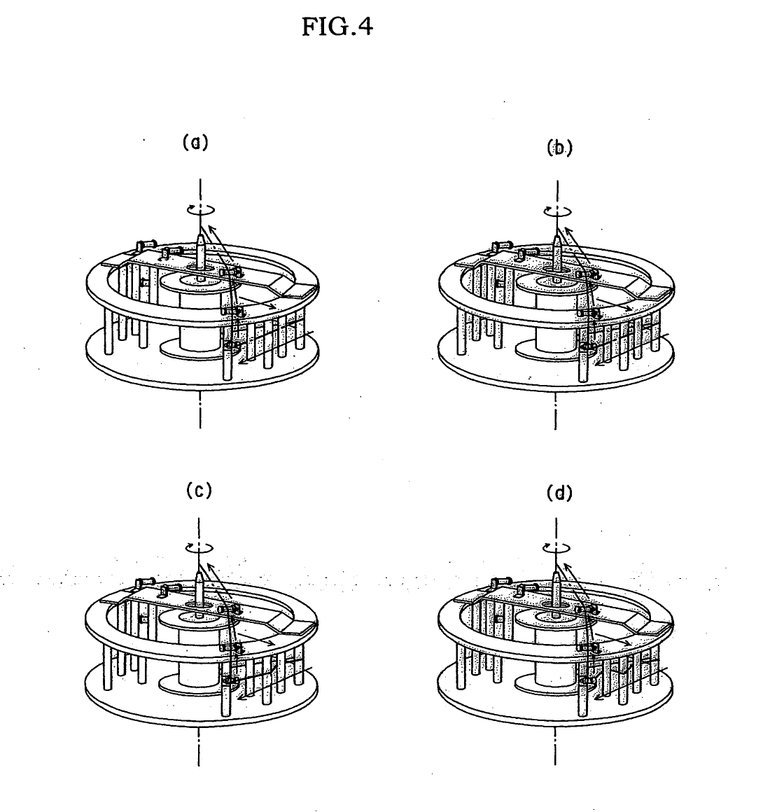

FIG. 3 is a perspective view showing a specific example of a main body part of the tape winding device of the present invention, and FIGS. 4 (a) to 4(d) are views each showing a specific example of the main body part of the winding device wherein a tape tension is made to be a predetermined value.

The system of manufacturing a tape-wound insulation core shown in FIG. 1 is composed of a feed unit 9 for feeding a wire material 10, a guide roll 11 for guiding the wire material 10 fed, tape winding devices 100 and 200, a take-up device 13 for taking up a tape-wound insulation core 12 wherein a tape body 1 is wound around the insulation core by means of the tape winding device, shaping dies 14 for shaping the tape-wound insulation core 12 into a complete circle having a predetermined outer diameter, guide rolls 16 and 17 for guiding a shaped core wire 15, and a winding unit 18.

The wire material 10 fed from the feed unit 11 is first guided by the guide roll 11 for passing the wire material through the tape winding device 100, the tape body 1 is wound around the wire material 10 guided in the tape winding device 100, thereafter a tape is succeedingly wound around the resulting tape-wound wire material in the tape winding device 200, and the tape-wound insulation core 12 wound is guided to the shaping dies 14 through the take-up device 13. In the shaping dies 14, the tape-wound insulation core 12 is shaped into a complete circular outline having a predetermined outer diameter, and the shaped core wire 15 is introduced to the winding unit 18 by means of the guide rolls 16 and 17 to be taken up.

The wire material 10 is typically an electric cable and the like, particularly a foamed coaxial cable in the invention, among others, it is an inner conductor being a core material of a high accuracy foamed coaxial cable wherein a characteristic impedance value is made to be ±1Ω. In the present invention, particularly an inner conductor having a thin diameter, for example, an inner conductor having an AWG size of 24 to 30 is suitable.

As the tape body 1, a porous tape body, particularly the one having 60% or more porosity and 1.4 or less dielectric constant (∈), for example, PTFE or polyethylene having a weight average molecular weight of five million or more is used. The tape body which has been calcined may be wounded, or the tape may be calcined during or after a winding operation.

The guide rolls are not necessarily provided separately so far as a tape body or the like is appropriately guided to the tape winding devices 100 and 200, the take-up device 13, the shaping dies 14, and the winding unit 18, besides they are not restricted to rolls. Furthermore, the number of guide rolls, and a shape and the like are not specifically limited.

The take-up device 13 has also a function for guiding the tape-wound insulation core 12 to the shaping dies 14, but it may be merely a guide roll, otherwise it may be a constitution wherein a guide roll is provided separately from the take-up device 13.

The shaping dies 14 are disposed between the take-up device 13 and the winding unit 18 and have a predetermined inner diameter and a predetermined inner diameter length, for example, 1.12 mm inner diameter and 3.00 mm inner diameter length. The tape-wound insulation core 12 is passed through the shaping dies 14 as described above to be shaped into a complete circular shape having an outer diameter of 1.12±0.02 mm. Shaping of the tape-wound insulation core 12 may be arranged in such that a plurality of, for example, two of shaping dies is applied to shape gradually the tape-wound insulation core.

Although double tape winding devices (100 and 200) are shown in FIG. 1, they may be a single tape winding device.

Next, the tape winding device 100 in FIG. 1 will be described in detail by referring to FIGS. 2 and 3.

The tape winding device 100 has a tape body feed section composed of a hollow shaft 101 through which the wire material 10 is passed forcibly along the center of a cross section of the shaft to guide the wire material, a tape pad 102 on which a tape body 1 is wound, a tape pad secure part 103 for securing the tape pad 102, a driving source connection part 104 provided on an end of the tape pad secure part 103, and a drive motor 106 connected to the driving source connection part 104 through a belt 105 or the like. The tape pad 102 is secured to the hollow shaft 101 through the tape pad secure part 103, but it may be secured directly to the hollow shaft 101. The tape pad secure part 103 is fixed to the outer circumference of the hollow shaft 101.

To the outside of the tape pad secure part 103, a tape winding flyer base plate 107 is attached in such that it is rotatable separately from the rotation of the tape pad secure part 103. A drive motor 109 is provided on one end of the tape winding flyer base plate 107 which is connected through a belt 108.

A plurality of tension control rolls 110 (110A to 110E) and 120 (120A to 120E) are implanted vertically to the tape winding flyer base plate 107, and a guide board 121 is provided on the other end of the tension control rolls. It is preferred that around three to seven each tension control rolls are disposed on the tape winding flyer base plate 107 in the sides opposite to each other with respect to the hollow shaft 101 as the boundary, and more preferable is in such that five each tension control rolls are disposed on the base plate in the opposite sides.

A shorting bar 126 having a throughhole 125 for passing the hollow shaft 101 therethrough is fitted to the guide board 121.

Tape guide rolls 122, 123, and 124 are provided on the tension control roll 110E, the guide board 121, and the shorting bar 126, respectively.

Each of the tape guide 122, 123, and 124 has also a function for reducing influence of a wind pressure applied to a tape itself produced by a rotation of the tape winding device 100 at the time of winding the tape in addition to another function for guiding the tape body 1 to the tip of the hollow shaft 101.

In FIGS. 2 and 3, although the tension control rolls 120 and 120A to 120E, a tape guide roll on the tension control roll 120E, the tape guide roll on the guide board 121 and opposite to the former tape guide roll, and the tape guide roll on the shorting bar 126 and opposite to the former tape guide roll are shown, they are members used for in a case where a winding direction of the tape body is reversed and they function for making the balance therefor to be constant with centering around a shaft of the tape winding device.

The above-described tension control rolls adjust a tension of a winding tape body, and a layout of which is constituted in such that the tension control rolls 110A, 110C, 110E and 120A, 120C, 120E are implanted vertically at positions each about 200 mm distant from the center of the wire material 10 passing through the hollow shaft 101, while the tension control rolls 110B, 110D and 120B, 120D are implanted vertically at positions each about 150 mm distant from the center of the wire material, and each of them is staggered (with deviations of 45 degrees (for example, an angle BAC is 45 degrees) towards the center side or the external side with respect to a straight line obtained by connecting the nearest two control rolls positioned from the same distance from the center of the wire material 10 (for example, 110A and 110C as well as 110B and 110D)), whereby a tape is guided to the tape guide rolls 122, 123, and 124. Moreover, these tension control rolls 100A to 110E and 120A to 120E are secured integrally between the tape-wound flyer tape winding flyer base plate 107 and the guide board 121.

A servo motor is used for the drive motor 106 which is controlled to be always in a torque set up irrespective of a tape-wound amount of the tape pad 102 based from a program by means of a sequencer according to torque control. It is programmed in such that when an actual torque is higher than the torque set up, a direction of reeling out a tape body is braked, while when an actual torque is less than the torque set up, the actual torque is braked.

As described above, when a torque is set up, a tension of a tape body can be made always to be constant in case of taking out a tape irrespective of a wound amount of a tape on the tape pad part.

For the drive motor 109, a servo motor is applied wherein it is programmed in such that the drive motor is rotated always at a number of revolutions set up, whereby the drive motor rotates around the outer circumference of the wire material 10 at a constant rotation to wind the tape body.

FIGS. 4(a) to 4(d) are specific examples each showing a main body section of a tape winding device for making a tape tension to be a predetermined value wherein a tension of a tape body itself relating to tape winding is decided by a contact area to be entwined with tension control rolls, i.e. a thickness of each tension control roll and a contact amount of a tape body abutting on a tension control roll. For instance, the tension control roll 110A is arranged in such that a thickness thereof is about 20 to 40 mm, and preferably about 30 mm, a contact angle is substantially 180 degrees, and a tension is determined by the angle and an area of a width in a tape body to be wound. In the present manner of practice, the tension control roll 110A is constituted so as to obtain a tape tension of about 0.2 N. In the case where a tension of a tape body is sufficient to be 0.2 N (FIG. 4(a)), the tape body is turned at the tension control roll 110A, and then it is introduced to a winding section through the tape guides 122, 123 and 124. When a tension of a tape body is made to be a further higher value, the tape body is entwined sequentially with the tensile control roll 110B (two turns: 0.4 N), 110C (three turns: 0.6 N), and 110D (four turns: 0.8 N) disposed at positions deviated about 45 degrees from the tension control roll 110A one another (FIGS. 4(b) to 4(d), whereby the tape body has about 90 degrees contact angle due to the intertwist, so that a tension of the tape body is determined by the angle and an area in a width of the tape body to be wound. In the present manner of practice, it is arranged in such that when a tape body is entwined with the tension control rolls 110B, 110C, and 110D, about 0.2 N tension is produced per a roll.

Next, a specific manner for winding actually a tape by means of a tape winding device will be described hereinafter.

First, a wire material of AWG #26 is traveled from the feed unit 9 to the winding unit 18 at a rate of 10 m/min. The calcined PTFE tape body 1 having a porosity of 60% or more, 4.6 mm tape width, and 0.09 mm thickness is wound around the outer circumference of the wire material 10 to be traveled with a ½ ply by means of the tape winding device 100. The tape body 1 to be wound is drawn from the tape pad 102, the tape body is entwined with the tension control roll 110A on the tape winding flyer base plate 107 to adjust a tension, and the tape body is fed to the tip of the hollow shaft 101 through the tape guide rolls 122, 123, and 124. When the driving motors 106 and 109 are driven to rotate the tape pad secure part 103 and the tape winding flyer base plate 107 at 100 rpm and 1500 rpm, respectively, whereby the tape body 1 is wound around the outer circumference of the wire material 10 guided in a hollow space of the hollow shaft 101 wherein differences in both the above-described numbers of revolutions derived from differences in outer circumferential diameters in the tape pad 102 and the tape winding flyer base plate 107.

Due to a rotation of the tape pad secure part 103, the tape body 1 is always reeled out with no tension, while the tape body is wound with no tension due to a rotation of the tape winding flyer base plate 107, but in reality, the tape body is entwined with the tension control rolls 110A, 110B, 110C, 110D and the like of the tape winding flyer base plate 107 to adjust a tension of the tape body. This tension adjustment does not require a readjustment, even if an amount of tape-wound in the tape pad 102 is changed.

In the present manner of practice, when a calcined PTFE tape having 4.6 mm tape width and 0.09 mm thickness is applied, about 0.4 N is a suitable tension. Thus, the calcined PTFE tape is entwined with the tension control rolls 110A and 110B in order to generate about 0.4 N tape tension (FIG. 4(b)). One tension control roll can generate a tension of about 0.2 N. It is to be noted that an actual tape tension in case of winding the tape body around the wire material 10 is around 0.5 N because of an influence by mechanical losses or the like in the tape guide rolls 122, 123, and 124.

As described above, it is arranged in such that a tape feed section makes a first drive source rotate to feed always a tape from a tape pad with no tension, a tape-wound section installed coaxially on the tape feed section in a rotatable manner makes a second drive source secured to an end thereof rotate to wind the tape with no tension, and a winding tension of the tape is made to be a constant value by means of tension control rolls of the tape-wound section. Accordingly, a PTFE porous tape body having a porosity of 60% or more and 0.09 mm thickness can be wound by the tape winding device.

As mentioned above, when a circumferential shield conductor is further provided on the outer circumference of the tape-wound insulation core 12 (a central conductor composed of the wire material 10 around which an insulator layer composed of the tape body 1 is wound), a coaxial cable having predetermined characteristic impedance can be obtained.

1. A tape winding device for a wire material, characterized by comprising a tape feed section composed of a hollow shaft having a throughhole for passing a wire material therethrough, a tape pad secure part secured to the hollow shaft for fixing a tape pad on which a tape body is wound, and a first drive source for driving rotatively the tape pad secure part; and
a tape winding section composed of a tape winding flyer installed coaxially on the outside of the tape feed section in a rotatable manner, a plurality of tension control rolls installed on a flat surface of the tape winding flyer parallel with the hollow shaft, and a second drive source connected to the tape winding flyer; and that:
the tape body is supplied from the tape pad to the tape winding flyer with a rotation by means of the first drive source, a tension of the tape body supplied to the tape winding flyer is made constant by means of the plurality of the tension control rolls, and the tape body is wound on the wire material at the tip of the hollow shaft by the rotation of the second drive source.

2. The tape winding device for a wire material as claimed in claim 1, characterized by that the tape pad secure part and the tape winding flyer are rotated in the same direction by the first drive source and the second drive source to wind the tape body on the wire material.

3. The tape winding device for a wire material as claimed in claim 1, characterized by that the tape winding flyer is composed of a disc-shaped base plate, the plurality of tension control rolls are implanted vertically on the base plate and the opposite ends of them are fitted to a guide board, and tape guide rolls functioning to introduce the tape body to the tip of the hollow shaft are provided on one or two or more of the plurality of tension control rolls and the guide board.

4. The tape winding device for a wire material as claimed in claim 3, characterized by that a shorting bar is secured to the top surface of the guide board, and the tape guide rolls are disposed on the shorting bar.

5. A system of manufacturing a tape-wound insulation core, characterized by comprising a tape feed section composed of a hollow shaft having a throughhole for passing a wire material therethrough, a tape pad secure part secured to the hollow shaft for fixing a tape pad on which a tape body is wound, and a first drive source for driving rotatively the tape pad secure part; and
a tape winding section composed of a tape winding flyer installed coaxially on the outside of the tape feed section in a rotatable manner, a plurality of tension control rolls installed on a flat surface of the tape winding flyer parallel with the hollow shaft, and a second drive source connected to the tape winding flyer;
the tape body being supplied from the tape pad to the tape winding flyer with a rotation by means of the first drive source, a tension of the tape body supplied to the tape winding flyer being made constant by means of the plurality of the tension control rolls;
one or plural tape winding devices for a wire material in which the tape body is wound on the wire material at the tip of the hollow shaft by the rotation of the second drive source;
a feed unit for feeding the wire material;
a take-over device for taking over the tape-wound insulation core prepared by winding the tape body on the wire material by means of the tape winding device;
an outline shaping device for shaping the tape-wound insulation core into a predetermined shape having a predetermined outer diameter; and
a take-up device for taking up the shaped tape-wound insulation core.

6. The system of manufacturing a tape-wound insulation core as claimed in claim 5, characterized by that the outline shaping device is disposed in between the take-over device and the take-up device, and composed of shaping dies including a complete circular hole having a predetermined inner diameter and a predetermined inner diameter length.

7. (canceled)
